(19) United States
(12) Patent Application Publication
(10) Pub. No.: US 2006/0123209 A1
(43) Pub. Date: Jun. 8, 2006

(54) Devices and methods of performing direct input/output operations using information indicative of copy-on-write status

(76) Inventor: Devin Borland, Nashua, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/006,205

(22) Filed: Dec. 6, 2004

(51) Int. Cl. G06F 12/16

(52) U.S. Cl. 711/162

(57) ABSTRACT

A file server maintains information indicative of which, if any, data stored on a storage medium, before being changed, needs to be copied to a snapshot. The file server communicates, to a client, at least a portion of the information for use by the client in determining whether to perform a direct input/output operation on the storage medium that would change data stored thereon.

### TECHNICAL FIELD

The following description relates to computing in general and to file systems in particular.

### BACKGROUND

Computers or other information processing devices typically store data on or in a storage medium such as a hard disk drive. A file system is typically used to organize, store, retrieve, and manage the stored data. As used herein, the term “volume” refers to the logical entity on which a file system operates. A volume is physically stored on or in one or more items of storage media.

In one configuration, a computer accesses a “local” volume that is physically stored on storage media that is local to or directly coupled to the computer (for example, storage media that is a part of the computer). In another configuration, multiple computers access a “shared” volume that is physically stored on storage media that the computers access over a network (for example, a local area network or a storage area network) in addition to or instead of any local volumes used by the computers. In one such configuration, one of the computers (referred to here as a “file server”) maintains information related to the shared volume (for example, file system meta data) and controls access to the storage media on which the shared volume is stored. The physical storage media on which a shared volume is stored is also referred to here as the “shared storage media.”

In one example of such a shared-volume configuration, when a client wishes to write data to or read data from the shared volume, the client sends to the file server a request that such a write or read operation be performed by the file server on behalf of the client. In the case of a write, the client sends to the file server the data to be written to the shared volume, which the file server receives and writes to the shared storage media. In the case of a read, the file serve reads the requested data from the shared storage media and sends the read data to the client.

In order to reduce the overhead associated with communicating data between clients and the file server in connection with such operations, some shared-volume configurations also support “direct” input/output (I/O) operations in which a client is able to write or read data directly to or from the shared storage media. When a client opens a file for writing, the file server sends the client information indicating where on the shared storage media that file is located. The client uses the location information provided by the file server to directly write data to the shared storage media.

Some file systems include functionality that allows a “snapshot” of a volume (also referred to here in this context as the “live volume”) to be created at a given point in time. A snapshot maintains a copy of the live volume as the volume existed at the time the snapshot was created. In order to reduce the amount of resources used to create and store a snapshot, a “copy-on-write” technique is typically used to create and maintain the snapshot. Initially, when the file system first “creates” the snapshot, data is not copied from the live volume to the snapshot. Instead, the snapshot contains meta data that references the same physical data stored on the storage media for the live volume. After the snapshot is created, when a write operation intends to overwrite data stored in the live volume at a particular location on the storage media, the data stored on the storage media at that location is first copied to a new location on the storage media. The meta data stored in the snapshot for that file (which previously referred to the first location on the storage media) is updated to refer to the new location on the storage media. After this “copy-on-write” is completed, the write operation is performed, which overwrites the data stored at the first location on the storage media.

In a shared-volume configuration, when snapshots are created and maintained using such copy-on-write techniques, the client are not typically allowed to perform direct write operations to shared storage media on which the live shared volume is stored. Instead, in such a configuration, all write operations are performed by the file server on behalf of the client, which requires the client to send the data to be written to the file server. Transferring data from the client to the file server in order to perform a write reduces the performance of the write.

### SUMMARY

In one embodiment, a method comprises maintaining information indicative of which, if any, data stored on a storage medium, before being changed, needs to be copied to a snapshot. The method further comprises communicating, to a client, at least a portion of the information for use by the client in determining whether to perform a direct input/output operation on the storage medium that would change data stored thereon.

In another embodiment, a method comprises, at a client that is communicatively coupled to a file server and a storage medium on which data are stored, receiving, from the file server, information indicative of which, if any, of at least a subset of the data need to be copied to a snapshot before being changed on the storage medium. The method further comprises, when the client intends to perform an input/output operation that would change any data included in the subset, determining, by the client based on the received information, if any data included in the subset needs to be copied to the snapshot before being changed on the storage medium. The method further comprises, when the client intends to perform the input/output operation, if any data included in the subset needs to be copied to the snapshot before being changed on the storage medium, requesting, by the client, that the file server copy to the snapshot the data included in the subset that needs to be copied to the snapshot before being changed on the storage medium and requesting that the file server perform the input/output operation on behalf of the client. The method further comprises, when the client intends to perform the input/output operation, if none of the data included in the subset needs to be copied to the snapshot before being changed on the storage medium, performing the input/output operation directly on the storage medium.

In another embodiment, a file server comprises a storage medium interface to communicatively couple the file server to a storage medium on which a file is stored and a client interface to communicatively couple the file server to at least one client. The file server provides, to the client, information indicative of whether any part of the file needs a copy-on-write to be performed therefor for use by the client in determining whether to perform a direct input/output operation to the file.

In another embodiment, a device comprises a storage medium interface to communicatively couple the device to a storage medium on which a file is stored and a file server interface to communicatively couple the device to a file server. The device receives, from the file server, information indicative of whether any part of the file needs a copy-on-write to be performed therefor. The device, when the device intends to perform an input/output operation on the file that would change at least a part of the file, uses the information to determine if the at least a part of the file needs a copy-on-write to be performed therefor. If the at least a part of the file needs a copy-on-write to be performed therefor, the client requests that the file server perform the copy-on-write for the at least a part the file and that the file server perform the input/output operation on the file on behalf of the client. If no part of the file needs a copy-on-write to be performed therefor, the device performs the input/output operation directly to the file.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a computer system.

FIG. 2 shows one example of a live storage map and a snapshot storage map for an exemplary file.

FIGS. 3A-3B are flow diagrams of one embodiment of methods of performing a write to a volume for which a snapshot has been created.

FIG. 4 shows the live storage map and snapshot storage map of FIG. 2 after a copy-on-write has been performed for the exemplary file.

Like reference numbers and designations in the various drawings indicate like elements.

### DETAILED DESCRIPTION

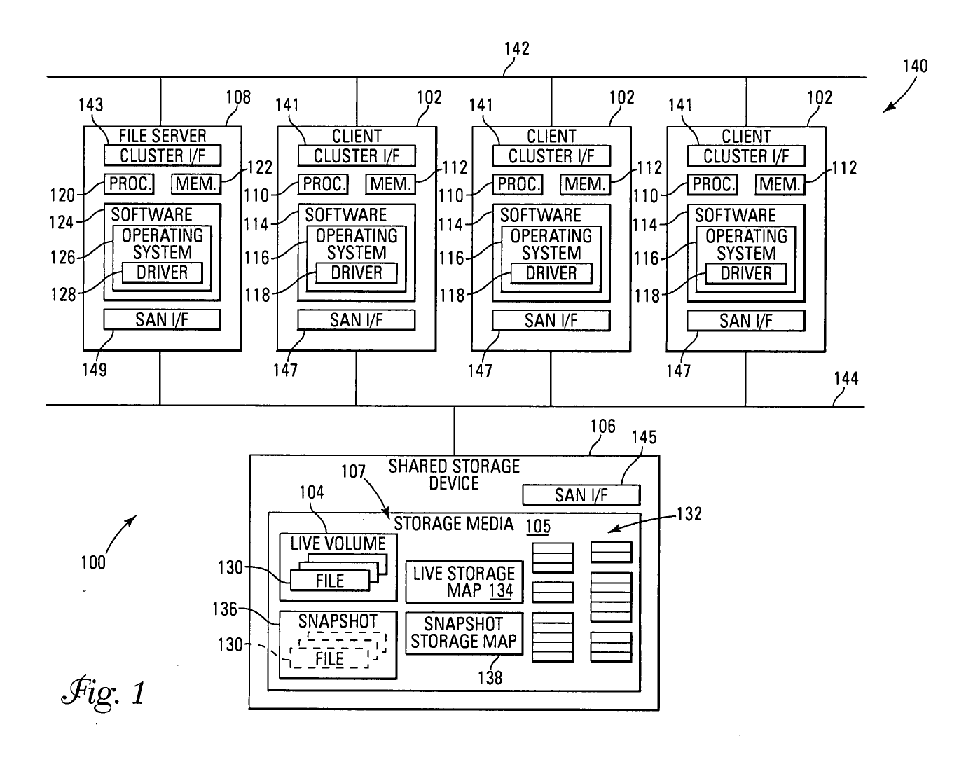

FIG. 1 is a block diagram of one embodiment of a computer system 100. The system 100 comprises one or more client devices 102 (for example, one or more computers or other information processing devices) (also referred to here as “clients” 102) that access a logical shared volume 104 (also referred to here as the “live volume” 104) stored on a shared storage device 106. The system 100 comprises a file server 108 that maintains information related to the shared volume 104 (for example, file system meta data) and controls access to shared storage device 106 on which the shared volume 104 and such meta data are stored. In the embodiment shown in FIG. 1, one volume 104 is stored on one storage device 106. The storage device 106 comprises a storage medium or media 105 (for example, one or more hard disks). In one implementation, the storage media 105 comprises multiple hard disks configured in a redundant array of independent disks (RAID) configuration. In some other embodiments, a different number of shared volumes, a different number of storage devices and/or different types of storage devices or storage media are used.

In the embodiment shown in FIG. 1, the clients 102, the shared storage device 106, and the file server 108 are a part of a cluster 140. The clients and the file server 108 are communicatively coupled to one another over a cluster interconnect 142. Each client 102 comprises an interface 141 (also referred to here as the “cluster” interface 141 or the “file server” interface 141) that communicatively couples the client 102 to the cluster interconnect 142 and to the other devices that are communicatively coupled thereto (that is, the file server 108 and the other clients 102). The file server 108 comprises an interface 143 (also referred to here as the “cluster” interface 143 or the “client” interface 143) that communicatively couples the file server 108 to the cluster interconnect 142 and to the other devices that are communicatively coupled thereto (that is, the clients 102). Each interface 141 and interface 143 comprises an appropriate interface for sending and receiving data on the cluster interconnect 142. In one implementation, the cluster interconnect 142 comprises a 100 megabit-per-second (Mbps) or 1000 Mbps ETHERNET local area network and each interface 141 and interface 143 comprise an ETHERNET network interface card (NIC) for coupling the respective device to such a local area network. In another implementation, the cluster interconnect 142 comprises an INFINIBAND or MEMORY CHANNEL interconnect and each interface 141 and interface 143 comprise an INFINIBAND or MEMORY CHANNEL interface for coupling the respective device to such an interconnect.

The shared storage device 106 is communicatively coupled to the clients 102 and the file server 108 using a storage area network (SAN) 144. The shared storage device 106 comprises an interface 145 (also referred to here as the “SAN” interface 145) that communicatively couples the shared storage device 106 to the SAN 144 and to the other devices communicatively coupled thereto (that is, the clients 102 and the file server 108). Each client 102 comprises an interface 147 (also referred to here as the “SAN” interface 147 or the “storage device” interface 147) that communicatively couples the client 102 to the SAN 144 and to the shared storage device 106. The file server 108 comprises an interface 149 (also referred to here as the “SAN” interface 149 or the “storage device” interface 149) that communicatively couples the file server 149 to the SAN 144 and to the shared storage device 106. In one implementation, the storage area network 144 comprises a fiber channel storage-area network having, for example, a point-to-point or switched topology. In such an implementation, the interface 145, each interface 147, and the interface 149 comprises a fiber channel network interface for coupling the respective device to such a fiber channel SAN.

In other embodiments, the clients 102, the shared storage device 106, and the file server 108 are communicatively coupled in other ways.

In the embodiment shown in FIG. 1, each of the clients 102 comprises at least one programmable processor 110 and memory 112. The memory 112 comprises, in one embodiment, any suitable form of memory now known or later developed, such as, for example, random access memory (RAM), read only memory (ROM), and/or processor registers. The programmable processor 110 executes software 114 (such as an operating system 116) that carries out at least some of the functionality described here as being performed by the clients 102. In one implementation, the operating system 116 comprises a driver 118 (also referred to here as a “file-system driver” 118) that implements at least some of the file-system-related processing described here as being performed by the clients 102. The software 114 is stored on or in a computer-readable medium from which the software 114 is read for execution by the programmable processor 110. In one implementation of such an embodiment, at least a portion of the software 114 is stored on the shared volume 104 and/or local storage device. In other embodiments, the software 114 is stored on other types of computer-readable media. A portion of the software 114 executed by the programmable processor 110 and one or more data structures used by the software 114 are stored in memory 114 during execution of the software 114 by the programmable processor 110.

In the embodiment shown in FIG. 1, the file server 108 comprises at least one programmable processor 120 and memory 122. The memory 122 comprises, in one embodiment, any suitable form of memory now known or later developed, such as, for example, random access memory (RAM), read only memory (ROM), and/or processor registers. The programmable processor 120 executes software 124 (such as an operating system 126) that carries out at least some of the functionality described here as being performed by the file server 108. In one implementation, the operating system 126 comprises a driver 128 (also referred to here as the “file-system driver” 128) that implements at least some of the file-system-related processing described here as being performed by the file server 108. The software 124 is stored on or in a computer-readable medium from which the software 124 is read for execution by the programmable processor 120. In one implementation of such an embodiment, at least a portion of the software 124 is stored on the shared volume 104 and/or local storage device. In other embodiments, the software 124 is stored on other types of computer-readable media. A portion of the software 124 executed by the programmable processor 120 and one or more data structures used by the software 124 are stored in memory 122 during execution of the software 124 by the programmable processor 120.

Data is stored on the storage media 105 of the shared storage device 106 in a plurality of physical storage units. A file system 107 is used to organize, store, retrieve, and manage the data stored on in the physical storage units on the storage media 105. In the embodiment shown in FIG. 1, the shared volume 104 is logically organized into multiple logical files 130 to which data can be written and from which data can be read. In such an embodiment, the data for a given file 130 is physically stored in one or more extents 132 on the storage media 105. Each extent 132 comprises one or more contiguous physical storage units on the storage media 105. In one implementation, each physical storage unit is 8 kilobytes in size. In other embodiments, physical storage units having other sizes are used. The file server 108 maintains a storage map 134 (also referred to here as the “live storage map 134”) for the volume 104 that maps the logical parts of each file 130 to the corresponding extents 132 at which those logical parts are stored on the storage media 105. The live storage map 134 contains entries for those files 130 that are currently stored in the volume 104. For each file 130 that is stored in the live volume 104 at a particular moment in time, the live storage map 134 contains one or more entries that point to (or otherwise reference) one or more extents 132 stored on the storage media 105 that contain the data stored in that file 130 at that particular moment in time.

In the embodiment shown in FIG. 1, the file server 108 creates a snapshot 136 of the live volume 104 at a given point in time. In the embodiment shown in FIG. 1, one snapshot 136 is maintained by the file server 108 at a time. In other embodiments, multiple snapshots are maintained. The file server 108 also maintains a storage map 138 (referred to here as the “snapshot storage map” 138) for the snapshot 136 that maps the logical parts of each file 130 “contained” in the snapshot 136 to the corresponding extents 132 at which those logical parts are stored on the storage media 105. The snapshot storage map 138 contains entries for those files 130 that existed in the live volume 104 at the time the snapshot 136 was created.

For each file 130 that existed in the live volume 104 at the time the snapshot 136 was initially created, the snapshot storage map 138 contains one or more entries that point to (or otherwise reference) one or more extents 132 stored on the storage media 105 that contain the data stored in that file 130 at the time the snapshot 136 was created. If a new file 130 is created and stored in the live volume 104 after the snapshot 136 was created, that new file 130 is not copied to the snapshot 136 and the snapshot storage map 138 does not contain an entry that references the new file 130. The new file 130 is not a part of the snapshot 136 because the new file 130 was not stored in the live volume 104 at the time the snapshot 136 was created.

Before a copy-on-write is performed for a particular part of a file 130 that is contained in the snapshot 136, the entries in the snapshot storage map 138 that correspond to that part of the file 130 point to the same one or more extents 132 that are pointed to by the entries in the live storage map 134 that correspond to that part of the file 130. A copy-on-write is performed for a particular part of a file 130 the first time, after the snapshot 136 was created, that the particular part of the file 130 is changed. For example, a copy-on-write is performed for a part of a file 130 before that part of the file 130 is written to. When a copy-on-write is performed on a part of a file 130, the data stored in that part of the file 130 is copied from the one or more extents 132 in which that data is stored to one or more new extents 132. The one or more entries in the snapshot storage map 138 for that part of the file 130 are updated to point to the new extents 132.

In the particular embodiment shown in FIG. 1, a copy-on-write need not be performed when a file 130 is deleted from the live volume 134. In such an embodiment, the file 130 is deleted by removing any entries in the live storage map 134 for that file 130. However, such a file deletion does not change the corresponding extents 132 in which the file 130 was stored. Therefore, the corresponding entries in the snapshot storage map 138 (if such file 130 is contained in the snapshot 136) need not be changed in connection with such a file deletion.

The file server 108 maintains information that is indicative of which of the extents 132 (and/or the logical entity corresponding thereto) on the shared storage device 106 need a copy-on-write performed therefor. In the embodiment shown in FIG. 1, such information is contained in the live storage map 134. For example, when each snapshot 136 is initially created, the entries in the live storage map 134 that correspond to each file 130 contained in the snapshot 136 are updated to indicate that each part of that file 130 (and the corresponding extents 132 at which each part is stored) needs a copy-on-write performed for that part (and the corresponding extent 132). After a copy-on-write is performed for a part of a file 130 (for example, before a write operation is performed on that part), the live storage map 134 is updated to indicate that a copy-on-write does not need to be performed for that part of the file 130 (or for the one or more extents 132 at which that part of the file 130 is stored).

Also, when a new file 130 is added to the live storage volume 104 after the snapshot 136 was created, the entries in the live storage map 134 for that new file 130 indicate that a copy-on-write does not need to be performed for any part of the new file 130 (or for any of the one or more extents 132 at which the new file 130 is stored).

When a client 102 wishes to make a change to a file 130, the file server 108 sends to the client 102 information indicating which part or parts of the file 130 (and the one or more extents 132 in which those parts are stored) need a copy-on-write performed therefor. Any such copy-on-write needs to be performed by the file server 108 before any data stored in such a part (or corresponding extent 132) is changed. The client 102, in connection with performing an input/output operation that would change a part of the file 130 (for example, a write), uses this information to determine if that part of file 130 needs a copy-on-write to be performed for that part. If a copy-on-write needs to be performed for that part of the file 130, the client 102 requests that the file server 108 perform any copy-on-writes that are needed and that the file server 108 perform the input/output operation on the client's behalf. However, if a copy-on-write does not need to be performed for that part of the file 130, the client 102 can perform the input/output operation directly on the shared storage device 106. Input/output operations performed directly by the client 102 typically are performed more quickly than input/output operations performed by the file server 108.

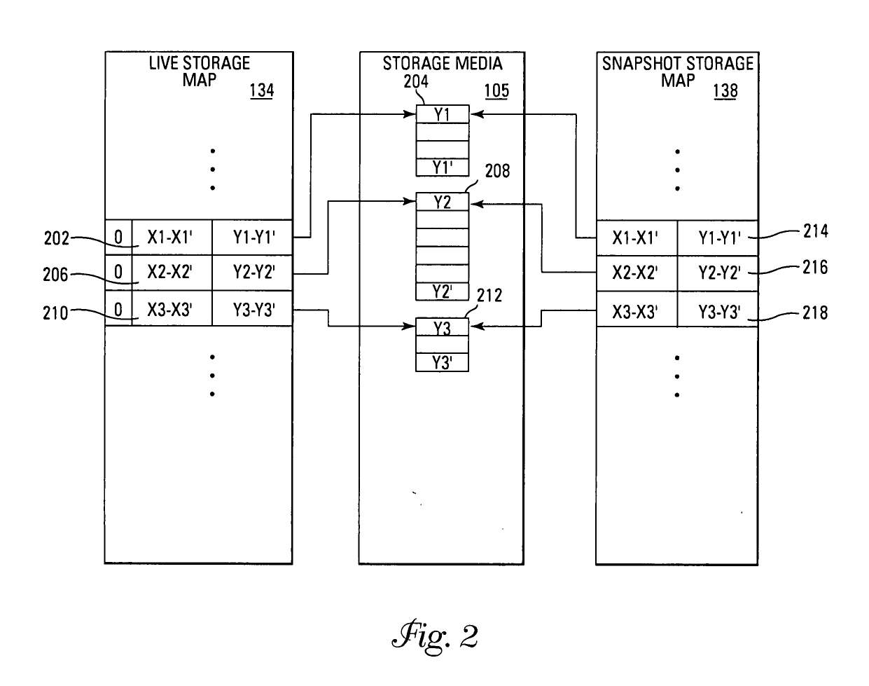

In one embodiment, a predetermined bit contained within an entry in the live storage map 134 is set in order to indicate whether a copy-on-write needs to be performed for the part of a file 130 (and the corresponding extent 132 pointed to by that entry). In one implementation of such an embodiment, the most-significant bit of each entry in the live storage map 134 is set to indicate that a copy-on-write does not need to be performed for the part of a file 130 (and the corresponding extent 132 pointed to by that entry). One such embodiment is illustrated in FIG. 2.

FIG. 2 illustrates the operation of the live storage map 134 and the snapshot storage map 138 for an exemplary file 130. In the example shown in FIG. 2, the live storage map 134 contains three entries for the example file 130. A first entry 202 in the live storage map 134 maps a first logical part of the example file 130 that starts at logical storage unit X1 in the live volume 104 and ends at logical storage unit X1′ in the live volume 104. The first entry 202 maps the first logical part of the file 130 to a first extent 204 that contains contiguous physical storage units on the storage media 105 starting at physical storage unit Y1 and ending at physical storage unit Y1′. A second entry 206 in the live storage map 134 maps a second logical part of the file 130 that starts at logical storage unit X2 in the live volume 104 and ends at logical storage unit X2′ in the live volume 104. The second entry 206 maps the second logical part of the file 130 to a second extent 208 that contains contiguous physical storage units on the storage media 105 starting at physical storage unit Y2 and ending at physical storage unit Y2′. A third entry 210 maps a third logical part of the file 130 that starts at logical storage unit X3 in the live volume 104 and ends at logical storage unit X3′ in the live volume 104. The third entry 210 maps the third logical part of the file 130 to a third extent 212 that contains contiguous physical storage units on the storage media 105 starting at physical storage unit Y3 and ending at physical storage unit Y3′.

In the example shown in FIG. 2, a copy-on-write has not been performed for any part of the example file 130. As result, the most-significant bit of each of the three entries 202, 206, and 210 in the live storage map 134 for the example file 130 are not set (that is, are equal to “0”). Also, because a copy-on-write has not been performed for any part of the opened file 130, the snapshot storage map 138 contains three entries 214, 216, and 218 for the example file 130 that map the same three logical parts of the file 130 to the extents 204, 208, and 212, respectively, on the storage media 105.

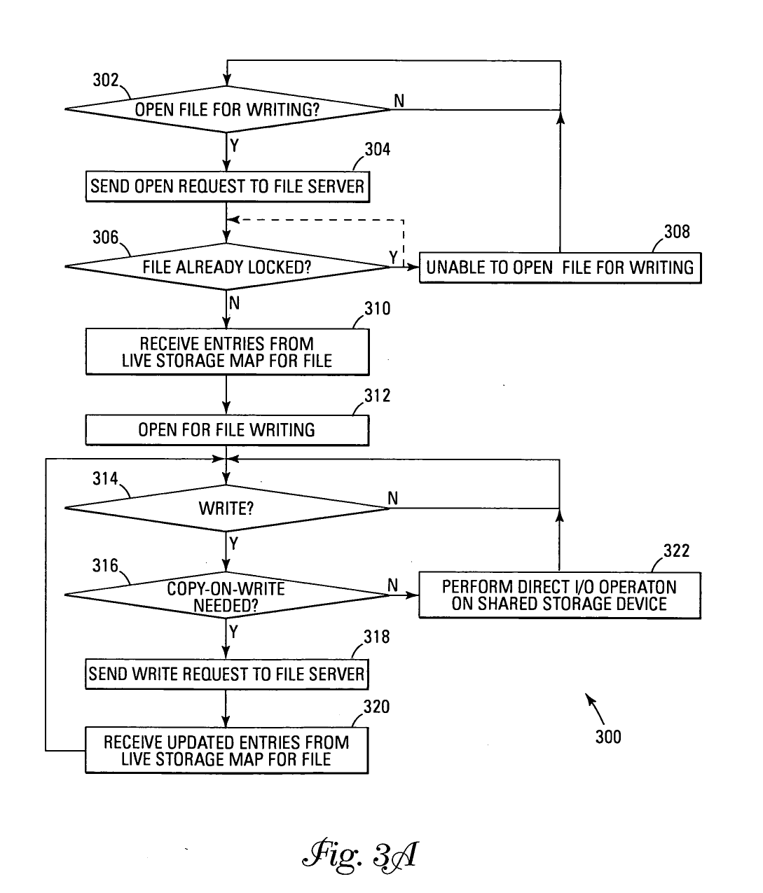

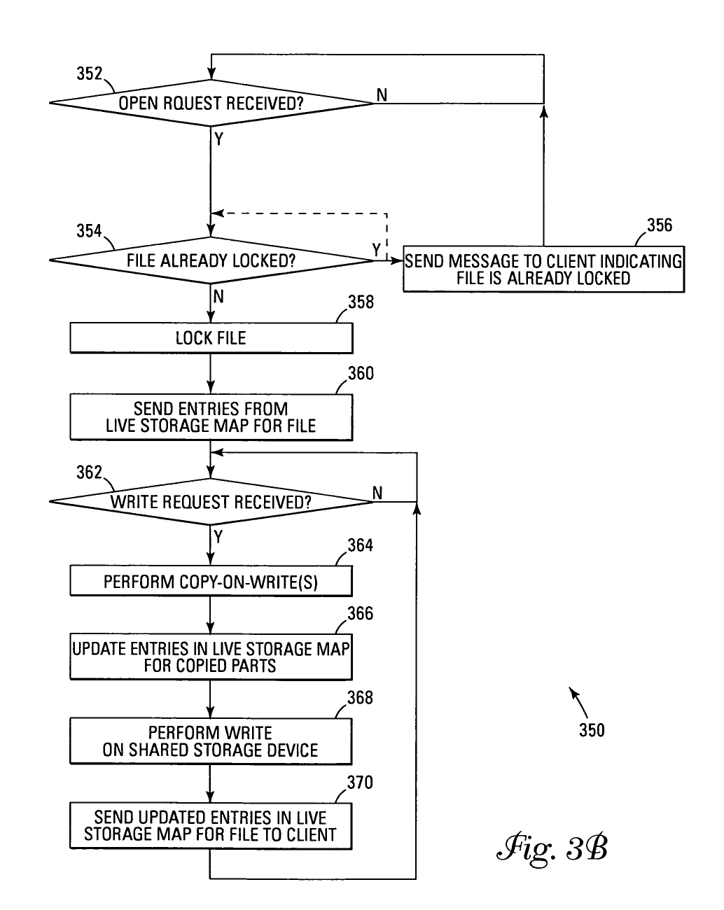

FIGS. 3A-3B are flow diagrams of one embodiment of methods 300 and 350, respectively, of performing a write to a volume for which a snapshot has been created. The embodiment of methods 300 and 350 shown in FIGS. 3A and 3B, respectively, are described here as being implemented using the system 100 of FIG. 1, though other embodiments are implemented in other ways and/or using other systems. In one implementation of the embodiment of method 300 shown in FIG. 3A, at least a portion of the functionality described here in connection with method 300 is performed by the file-system driver 118 of each client 102. In one implementation of the embodiment of method 350 shown in FIG. 3B, at least a portion of the functionality described here in connection with method 350 is performed by the file-system driver 128 of the file server 108.

When a client 102 wishes to open a file 130 for writing (checked in block 302 of FIG. 3A), the client 102 sends a request to the file server 108 indicating that the client 102 wishes to open the file 130 for writing (block 304). In one embodiment, such an open request is sent from the client 102 to the file server 108 over the cluster interconnect 142.

When the file server 108 receives the request from the client 102 (checked in block 352 of FIG. 3B), the file server 108 checks if the file 130 is currently locked (block 354). If the file 130 is locked, the file server 108 sends a message to the client 102 indicating that the file 130 is locked (block 356). If the file 130 is not locked, the file server 108 locks the file 130 for the client 102 (block 358) and sends to the client 102 the one or more entries in the live storage map 134 that correspond to that file 130 (block 360).

If the client 102 receives a message indicating that the file 130 is locked (checked in block 306 of FIG. 3A), the client 102 is unable to open the file 130 for writing (block 308). In an alternative embodiment (shown in FIGS. 3A and 3B with dashed lines), when the file 130 is locked for a device other than the client 102, the file server 108 and the client 102, instead of aborting the attempt to open the file 130 for writing, wait for the other device to release the lock on the file 130 and, after the other device releases the lock, proceed with the other processing described here.

If the file 130 is not locked, the client 102 receives from the file server 108 the one or more entries from the live storage map 134 that correspond to the file 130 (block 310) and opens the file for writing (block 312).

When the client 102 wishes to write to a particular region of the opened file 130 (checked in block 314), the client 102 uses the received entries to determine if a copy-on-write needs to be performed for any part of that region of the file 130 (checked in block 316). The region of the file 130 to which the client 102 wishes to write is also referred to here as the “targeted” region of the file 130. Any part of the targeted region for which a copy-on-write needs to be performed is also referred to here as an “uncopied” part of the targeted region. In the embodiment shown in FIG. 3A, the client 102 determines if there are any uncopied parts of the targeted region by checking the most-significant bit of each of the one or more entries from the live storage map 134 that corresponds to the targeted region of the opened file 130. In such an embodiment, if the most-significant bit of such an entry is set, a copy-on-write does not need to be performed for the extent 132 referenced by that entry. If the most-significant bit of such an entry is not set, a copy-on-write needs to be performed for the extent 132 referenced by that entry.

If a copy-on-write needs to be performed for a part of the targeted region of the file 130, the client 102 sends a request to the file server 108 requesting the file server 108 perform any needed copy-on-writes and perform the write on behalf of the client 102 (block 318). The client 102 identifies, for the file server 108, the targeted region of the file 130 and sends to the file server 108 the data to be written to the targeted region of the file 130. The data that is to be written to the targeted region of the file 130 is also referred to here as the “write data.”

When the file server 108 receives the write request (checked in block 362 of FIG. 3B), the file server 108 performs a copy-on-write for the uncopied parts of the targeted region of the file 130 (block 364). The file server 108, in the embodiment shown in FIG. 3B, identifies the uncopied parts of the targeted region in the same way as the client 102 (that is, by checking the most-significant bit of each entry associated with the targeted region). For each uncopied part of the targeted region, the file server 108 uses the one or more entries in the snapshot storage map 138 to identify the one or more extents 132 at which the uncopied part is stored on the storage media 105 of the shared storage device 106. The file server 108 copies the data stored in the identified extents 132 to one or more new extents 132 that are stored on the storage media 105. The file server 108 updates the one or more entries in the snapshot storage map 138 that correspond to the targeted part of the file 130 to point to the one or more new extents 132. The file server 108 also updates the live storage map 134 to indicate that a copy-on-write operation does not need to be performed for the targeted part of the file 130 (block 366). In one embodiment, the file server 108 does this by setting the most-significant bit of the one or more entries in the live storage map 134 for which the copy-on-write was performed.

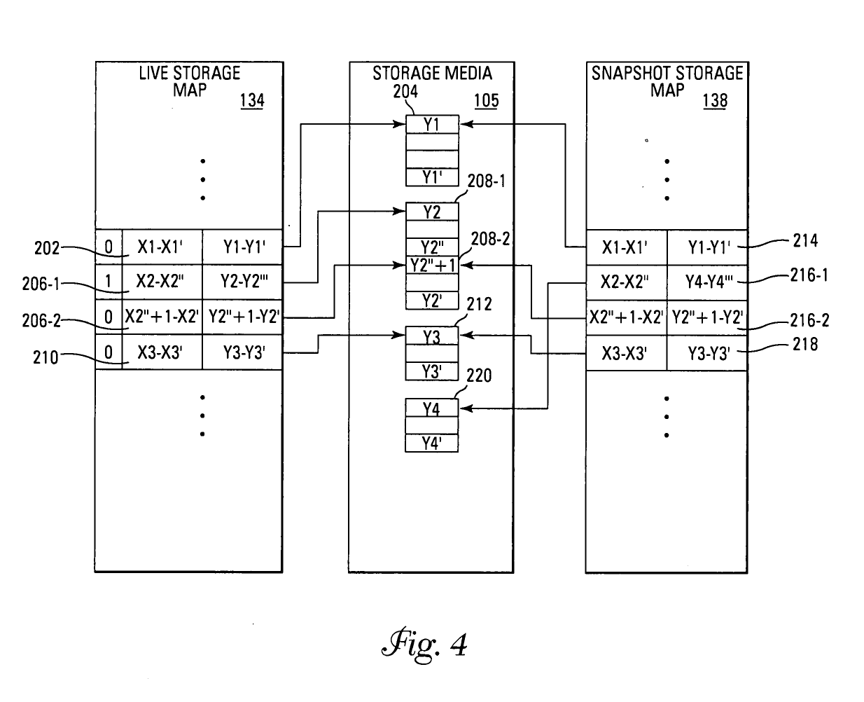

In one implementation of such an embodiment, when an uncopied part of the targeted region is stored in less than all of the physical storage units that make up a particular extent 132 (referred to here as the “original extent” 132), the file server 108 performs a copy-on-write for only those storage units in which the uncopied part of the targeted region is stored and “splits” the original extent 132 into two extents as described below in connection with FIG. 4. In other implementations, copy-on-write operations are performed on entire extents 132 and no splitting is performed.

After the copy-on-write is complete, the file server 108 writes the write data to the targeted part of the file 130 (block 368 of FIG. 3B). That is, the file server 108 writes the write data to the extents 132 on the storage media 105 in which data for the targeted part of the opened file 130 is stored (as indicated by the live storage map 134). The file server 108 also sends to the client 102 the updated entries from the live storage map 134 that correspond to the opened file 130 (block 370).

The client 102 receives the updated entries from the live storage map 134 for the opened file 130 (block 320 of FIG. 3A) and uses the updated entries for subsequent I/O operations performed on the opened file 130 (looping back to block 314).

When the client 102 wishes to write to a particular part of the opened file 130 and the client 102 (based on the entries from the live storage map 134) determines that a copy-on-write does not need to be performed for the targeted region of the file 130, the client 102 directly writes the write data to the one or more extents 132 in which the targeted region of the file 130 is stored on the storage media 105 (block 322). In this way, the client 102 is able to perform direct writes to the storage media 105 when the targeted region has already been copied into the snapshot 136. As a result, the write data need not be transferred to the file server 108 over the cluster interconnect 142 in order to carry out a write to the storage media 105.

The operation of one implementation of the embodiment of method 350 shown in FIG. 3B is illustrated in FIG. 4. FIG. 4 shows the entries contained in the live storage map 134 and the snapshot storage map 138 for the exemplary file 130 of FIG. 2 after a copy-on-write is performed for the exemplary file 130. In this example, a client 102 wishes to perform a write operation to a portion of the second logical part of the exemplary file 130. The portion to which data is to be written (that is, the targeted region of the write) starts at the logical storage unit X2 in the live volume 104 and ends at logical storage unit X2″ in the live volume 104, where the logical storage unit X2″ comes before the logical storage unit X2′. In this example, the targeted region is stored in the part of the second extent 208 that starts at physical storage unit Y2 on the storage media 105 and ends at physical storage unit Y2″ on the storage media 105, where the physical storage unit Y2″ comes before the physical storage unit Y2′ on the storage media 105.

As shown in FIG. 4, the file server 108, in performing the copy-on-write, creates a new extent 220 that contains contiguous physical storage units on the storage media 105 starting at physical storage unit Y4 and ending at physical storage unit Y4′. In performing the copy-on-write, the file server 108 copies the data stored in the contiguous physical storage units stored in the second extent 208 starting at the physical storage unit Y2 and ending at the physical storage unit Y2″. The file server 108 copies the data to the new extent 320. The file server 108 also “splits” the second extent 208 into two extents 208-1 and 208-2. The extent 208-1 contains the contiguous physical storage units in the storage media 105 starting at storage unit Y2 and ending at storage unit Y2″. The other extent 208-2 contains the contiguous physical storage units in the storage media 105 starting at storage unit Y2″+1 and ending at storage unit Y2′. The file server 108 also “splits”.the second entry 206 contained the live storage map 134 into two entries 206-1 and 206-2. The entry 206-1 maps the logical part of the example file 130 that starts at logical storage unit X2 in the live volume 104 and ends at logical storage unit X2″ in the live volume 104 to the extent 206-1. The other entry 206-2 maps the logical part of the example file 130 that starts at logical storage unit X2″+1 in the live volume 104 and ends at logical storage unit X2′ in the live volume 104 to the extent 206-2. The file server 108 sets the most-significant bit of the entry 206-1 to indicate that a copy-on-write does not need to be performed for the first extent 206-1 and does not set the most-significant bit of the entry 206-2 to indicate that a copy-on-write still needs to be performed for the extent 208-2.

As shown in FIG. 4, the file server 108 also “splits” the second entry 216 in the snapshot storage map 138 into two entries 216-1 and 216-2. The entry 216-1 maps the logical part of the exemplary file 130 that starts at logical storage unit X2 in the live volume 104 and ends at logical storage unit X2″ in the snapshot 136 to the new extent 220. The other entry 216-2 maps the logical part of the example file 130 that starts at logical storage unit X2″+1 in the live volume 104 and ends at logical storage unit X2′ in the snapshot 136 to the extent 206-2.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory previously or now known or later developed, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and DVD disks. Any of the foregoing may be supplemented by, or incorporated in, specially-designed application-specific integrated circuits (ASICs).

What is claimed is:

1. A method comprising:
maintaining information indicative of which, if any, data stored on a storage medium, before being changed, needs to be copied to a snapshot; and
communicating, to a client, at least a portion of the information for use by the client in determining whether to perform a direct input/output operation on the storage medium that would change data stored thereon.

2. The method of claim 1, wherein the information is maintained by a file server that is communicatively coupled to the storage medium.

3. The method of claim 1, wherein the direct input/output operation comprises a direct write.

4. The method of claim 1, further comprising, when the client intends to perform an input/output operation that would change data stored on the storage medium and the client determines, based on the at least a portion of the information, that at least of a part of the data that would be changed by the input/output operation needs to be copied to the snapshot:
copying, by the file server, the at least a part of the data that would be changed by the input/output operation to the snapshot;
updating, by the file server, the information;
performing, by the file server, the input/output operation for the client;
communicating, by the file server, at least a portion of the updated information to the client.

5. The method of claim 1, wherein the data is stored on the storage medium in a plurality of physical storage units, wherein the method further comprises maintaining a mapping of a plurality of logical storage units to respective physical storage units on the storage medium, wherein the information is maintained in the mapping.

6. The method of claim 5, wherein the information comprises information indicative of which, if any, of the plurality of logical storage units need to be copied to the snapshot before changing data stored therein.

7. The method of claim 5, wherein the physical storage units are organized into a plurality of extents, wherein each extent comprises a set of contiguous physical storage units, wherein the information comprises information indicative of which, if any, of the set of contiguous physical storage units need to be copied to the snapshot before changing data stored therein.

8. A computer program product comprising program instructions embodied on a computer-readable medium operable to cause a programmable processor of a file server to:
maintain information indicative of which, if any, data stored on a storage medium, before being changed, needs to be copied to a snapshot; and
communicating, to a client, at least a portion of the information for use by the client in determining whether to perform a direct input/output operation on the storage medium that would change data stored thereon.

9. The computer program product of claim 8, wherein the program instructions comprise an operating system.

10. A method comprising:
at a client that is communicatively coupled to a file server and a storage medium on which data are stored:
receiving, from the file server, information indicative of which, if any, of at least a subset of the data need to be copied to a snapshot before being changed on the storage medium; and
when the client intends to perform an input/output operation that would change any data included in the subset, by the client:
determining, based on the received information, if any data included in the subset needs to be copied to the snapshot before being changed on the storage medium;
if any data included in the subset needs to be copied to the snapshot before being changed on the storage medium, requesting that the file server copy to the snapshot the data included in the subset that needs to be copied to the snapshot before being changed on the storage medium and requesting that the file server perform the input/output operation on behalf of the client; and
if none of the data included in the subset needs to be copied to the snapshot before being changed on the storage medium, performing the input/output operation directly on the storage medium.

11. The method of claim 10, further comprising receiving, from the file server, updated information.

12. The method of claim 10, wherein a file is stored in the subset of data stored on the storage medium.

13. The method of claim 12, further comprising sending to the file server an open request for the file, wherein the information comprises file information that indicates which, if any, part of the file needs to copied to the snapshot before being changed on the storage medium.

14. The method of claim 10, wherein:
the data is stored on the storage medium in a plurality of physical storage units;
a storage map maps a plurality of logical storage units to respective physical storage units on the storage medium; and
the information is included in the storage map.

15. A computer program product comprising program instructions embodied on a computer-readable medium operable to cause a programmable processor of a client to:
at a client that is communicatively coupled to a file server and a storage medium on which data are stored:
receive, from the file server, information indicative of which, if any, of at least a subset of the data need to be copied to a snapshot before being changed on the storage medium; and
when the client intends to perform an input/output operation that would change any data included in the subset, by the client:
determine, based on the received information, if any data included in the subset needs to be copied to the snapshot before being changed on the storage medium;
if any data included in the subset needs to be copied to the snapshot before being changed on the storage medium, request that the file server copy to the snapshot the data included in the subset that needs to be copied to the snapshot before being changed on the storage medium and request that the file server perform the input/output operation on behalf of the client; and
if none of the data included in the subset needs to be copied to the snapshot before being changed on the storage medium, perform the input/output operation directly on the storage medium.

16. The computer program product of claim 15, wherein the program instructions comprise an operating system.

17. A file server comprising:
a storage medium interface to communicatively couple the file server to a storage medium on which a file is stored;
a client interface to communicatively couple the file server to at least one client;
wherein the file server provides, to the client, information indicative of whether any part of the file needs a copy-on-write to be performed therefor for use by the client in determining whether to perform a direct input/output operation to the file.

18. The file server of claim 17, wherein the direct input/output operation comprises a direct write.

19. The file server of claim 17, further comprising an operating system operable to cause a programmable processor to provide the information to the client.

20. The file server of claim 17, wherein the client interface comprises a local area network interface.

21. The file server of claim 17, wherein the client interface comprises a cluster interconnect.

22. The file server of claim 17, wherein the storage medium interface comprises a storage area network interface.

23. The file server of claim 17, wherein, when the client intends to perform an input/output operation on the file that would change at least a part of the file and the client determines, based on the information, that the at least a part of the file needs a copy-on-write to be performed therefor, the file server performs the copy-on-write for the at least a part of the file and performs the input/output operation on the file on behalf of the client.

24. The file server of claim 23, wherein after the file server performs the copy-on-write for the at least a part of the file, the file server updates the information and communicates the updated information to the client for use thereby.

25. A device comprising:
a storage medium interface to communicatively couple the device to a storage medium on which a file is stored;
a file server interface to communicatively couple the device to a file server;
wherein the device receives, from the file server, information indicative of whether any part of the file needs a copy-on-write to be performed therefor;
wherein the device, when the device intends to perform an input/output operation on the file that would change at least a part of the file, uses the information to determine if the at least a part of the file needs a copy-on-write to be performed therefor;
wherein if the at a least a part of the file needs a copy-on-write to be performed therefor, the client requests that the file server perform the copy-on-write for the at least a part the file and that the file server perform the input/output operation on the file on behalf of the client; and
wherein if no part of the file needs a copy-on-write to be performed therefor, the device performs the input/output operation directly to the file.

26. The device of claim 25, further comprising an operating system operable to cause a programmable processor included in the device to use the information to determine if the at least a part of the file needs a copy-on-write to be performed therefor.

27. The device of claim 25, wherein the device receives updated information from the file server.

28. The device of claim 25, wherein the device sends, to the file server, an open request for the file.

29. The device of claim 25, wherein a storage map maps each part of the file to a respective region of the storage medium at which the respective part is stored thereon.

30. A server comprising:
means for communicatively coupling the server to a storage medium on which data is stored;
means for communicatively coupling the server to at least one client;
means for maintaining information indicative of which, if any, of the data stored on the storage medium, before being changed, needs to be copied to a snapshot; and
means for communicating, to the client, at least a portion of the information for use by the client in determining whether to perform a direct input/output operation on the storage medium that would change data stored thereon.

31. A client comprising:
means for communicatively coupling the client to a storage medium on which data is stored;
means for communicatively coupling the client to a file server;
means for receiving, from a file server communicatively coupled to the client, information indicative of which, if any, of at least a subset of the data need to be copied to a snapshot before being changed on the storage medium;
means for performing an input/output operation that would change data stored in the subset of data, wherein the means for performing the input/output operation comprises:
means for determining, based on the received information, if any data included in the subset needs to be copied to the snapshot before being changed on the storage medium;
means for, if any data included in the subset needs to be copied to the snapshot before being changed on the storage medium, requesting that the file server copy to the snapshot the data included in the subset that needs to be copied to the snapshot before being changed on the storage medium and requesting that the file server perform the input/output operation on behalf of the client; and
means for, if none of the data included in the subset needs to be copied to the snapshot before being changed on the storage medium, performing the input/output operation directly on the storage medium.
